(19) United States
(12) Patent Application Publication
(10) Pub. No.: US 2012/0180468 A1
(43) Pub. Date: Jul. 19, 2012

(54) AUTOMOBILE ENERGY ABSORBING AND ACTUATING SYSTEM, METHOD, AND APPARATUS

(76) Inventor: Travis Knapp, Austin, TX (US)

(21) Appl. No.: 13/351,826

(22) Filed: Jan. 17, 2012

Related U.S. Application Data
(60) Provisional application No. 61/433,424, filed on Jan. 17, 2011.

(51) Int. Cl. B60T 1/10; B60K 7/00

(52) U.S. Cl. 60/407

(57) ABSTRACT

A system and associated devices that can be used to transform vibrational energy absorbed by the wheels of an automobile into captured energy for use by the automobile. A method to charge an automobile's electric battery without burning fuel and in a shorter time period than prior approaches. A method to assure a smooth drive for an automobile by reducing vibrations associated with the automobile. An apparatus that provides for the vector superposition of the magnetic fields from a plurality of adjacent permanent magnets and maximizes radial magnetic flux density within coil windings for optimal power generation and energy conversion efficiency of an automobile. A system, method, and apparatus for compressing air resulting from the passage of a automobile over a roadway, thereby providing generation of power for the automobile.

### FIELD OF THE INVENTION

The invention relates to traffic-actuated generator apparatus in which energy from a passing automobile is used to compress air which may be translated into mechanical and/or electrical energy. A system, method, and apparatus are provided that enables compressing of air resulting from the passage of an automobile over a roadway, thereby providing generation of power for the automobile.

### BACKGROUND OF THE INVENTION

Vehicle efficiency is reduced by mechanical energy losses dissipated as heat from braking, aerodynamic drag, and road resistance. Energy efficiency in both electric vehicles and conventional gasoline powered vehicles is generally compromised by road resistance with associated parasitic energy losses caused by mechanical displacements produced by road bumps and road roughness.

Thus, innovative devices that can recover energy losses within minimum vehicle weight penalty would be highly desirable for improving the overall energy efficiency of both conventional fossil fuel powered and electric powered vehicles.

Various types of devices have been used in the past to provide energy generation for automobiles. These devices required the use of fuels and/or would need to be retrofitted. Also in the past, various devices have been placed on the roadway to absorb momentum from the automobile towards energy generation.

In view of the shortcomings of the above-mentioned approaches, there exists a need for facilitating energy generation of an automobile without the use of fuel and providing the recharging of an electric battery in an automobile at lower cost and lower complexity.

### BRIEF SUMMARY OF THE INVENTION

The present disclosure provides a system and associated devices that can be used to transform vibrational energy absorbed by the wheels of an automobile into captured energy for use by the automobile. It is an object of the invention to charge an automobile's electric battery without burning fuel and in a shorter time period than prior approaches.

One aspect of the disclosed subject matter is providing a system, method, and apparatus for compressing air resulting from the passage of an automobile over a roadway, thereby providing generation of power for the automobile. The present disclosures teaches an air-engine mechanism comprising at least one of each of wheel, spring, casing, automobile frame, energy generator, hub-to-air rim element, air piston, pump, cylinder, compressor, pinion, and rack.

Yet another aspect of the disclosed subject matter is a system, method, and apparatus for providing energy without the use of fuel.

Another aspect of the disclosed subject matter is to assure a smooth drive for an automobile by reducing vibrations associated with the automobile.

Yet another aspect of the disclosed subject matter is a system, method, and apparatus that may be applied to various types of automobiles, which may be, but is not limited to, cars, trucks, and military automobiles.

Another aspect of the disclosed subject matter is a system, method, and apparatus that may be applied to any type of conversion and recovery of electrical energy from repetitive displacement motion, forces and vibrations from a variety of sources, which may include, but is not limited to, stationary or portable machinery, vehicles, boats, trains, aircraft, tidal current, ocean wave motion, military transportation, bridges, and railways.

An additional aspect of the disclosed subject matter is allowing capture and transformation of vibrational energy from a roadway to power an eighteen wheeler truck.

Yet another aspect of the disclosed subject matter is providing the recharging of an electric battery in an automobile at lower cost and lower complexity.

An additional aspect of the disclosed subject matter is allowing energy generation to existing automobiles without retrofitting.

Yet another aspect of the disclosed subject matter is allowing the harnessing of kinetic energy by an automobile towards conducting useful work by an automobile.

An additional aspect of the disclosed subject matter is to provide a generator for converting waster kinetic energy from linear displacement motion and vibrations into useful electric energy.

Yet another aspect of the present disclosure is to provide an electromagnetic generator where movable arrays of coil windings are positioned within regions of maximum average radial magnetic flux density formed by the vector superposition of the magnetic field from a plurality of neighboring magnets.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims filed later.

### BRIEF DESCRIPTIONS OF THE DRAWINGS

The novel features believed characteristic of the invention will be set forth in any claims that are filed later. The invention itself, however, as well as a preferred mode of use, further objectives, and advantages thereof, will best be understood by reference to the following detailed description of an illustrative embodiment when read in conjunction with the accompanying drawings, wherein:

FIG. 1 depicts an exemplary layout of the passage of an automobile along a roadway.

FIG. 2 illustrates the system, method, and apparatus for actuating the energy that is absorbed by an automobile.

FIG. 3 portrays the automobile frame and energy generator as described in the present disclosure.

FIG. 4 shows a conceptual view of the energy generator.

FIG. 5 displays an air tank, which may be comprised of a casing and a compressor.

FIG. 6 shows a rack and pinion that may be utilized to transmit energy to energy generator.

FIG. 7 illustrates a plurality of air tanks arranged to achieve an efficient pressure response.

FIG. 8 portrays an embodiment of the energy generator.

FIG. 9 shows an embodiment system, method, and apparatus for actuating the energy that is absorbed by an automobile.

FIG. 10 displays a perspective view of an embodiment system, method, and apparatus for actuating the energy that is absorbed by an automobile.

FIG. 11 depicts an automobile with an exemplary system, method, and apparatus for actuating vibrational energy.

### DETAILED DESCRIPTION OF ILLUSTRATIVE EMBODIMENTS

Although described with particular reference to energy conversion devices for automobiles, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

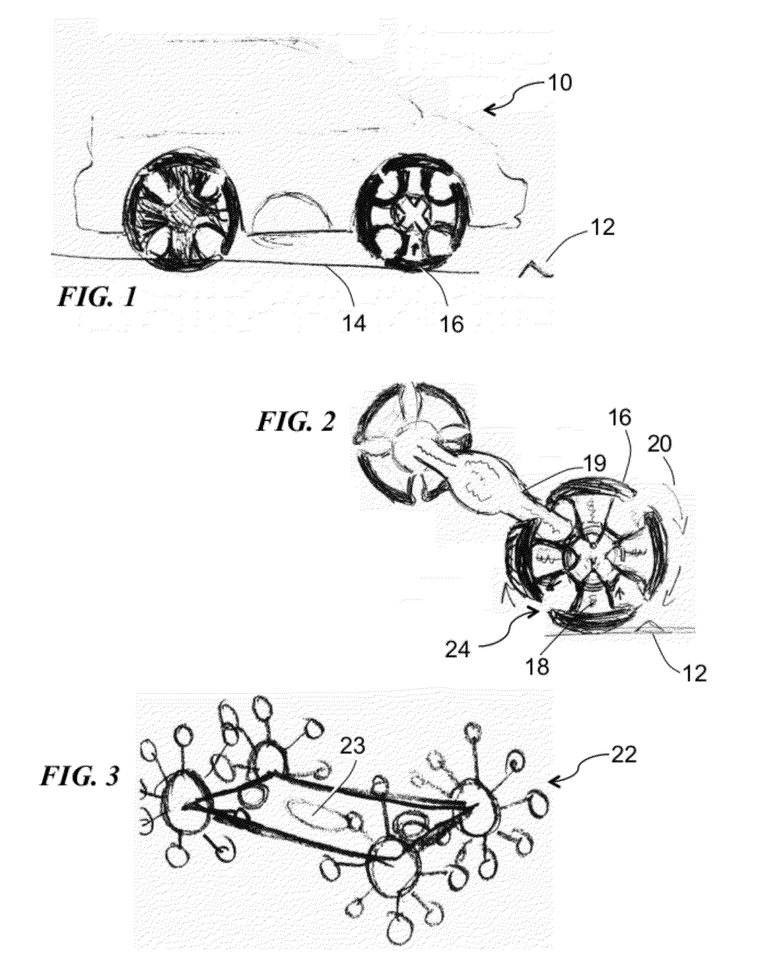

With reference to FIG. 1, an exemplary layout of the passage of automobile 10 along roadway 14. The roadway 14 may contain bump 12, which may be associated with unevenness. Bump 12 may have been created artificially, and may be a mechanical speed bump or an electrically-controlled speed bump, or may be associated with rocks or the natural roughness of the terrain. As automobile 10 moves over bump 12, vibrational energy in generated and transmitted to wheel 16.

The impact of wheel 16, which may be a subcomponent of automobile 10, over bump 12 provides kinetic energy that may be harnessed by automobile 10 to perform useful work. Further wheel 16 may be comprised of a safe carbon material and/or rubber material. Further, typical bump 12 amplitude dimensions inherent in roadway 14 may, but is not limited to, being on the order of one to six millimeters.

FIG. 2 illustrates the system, method, and apparatus for actuating the energy that is absorbed by automobile 10 while ensuring a smooth ride via a reduction of vibration felt by the passenger. A plurality of energy generator 24 is positioned through the circumference of wheel 16. The rotation 20 of wheel 14 over bump 12 actuates energy generator 24, thereby compressing spring 18 and providing useful work for automobile 10.

Energy generator 24 may generate energy may be associated with, but not limited to, an air generator, electric generator, or water generator. In the case of an air generator, the air inside of casing 19 is compressed.

As automobile 10 is being driving, spring 18 may become locked if desired. The continuous movement of automobile 10 over a plurality of bumps 12 consequently creates a continuous generation of energy through translation caused by exemplary system, method, and apparatus for actuating the energy that is herein described.

FIG. 3 portrays the automobile frame 22 and battery 23. The frame 22 contains more independent suspensions than is typical of four-wheel independent suspensions in automobiles. The frame 22 may contain springs, shocks, and/or stabilizers to capture energy and transform from multiple pistons and provide useful energy for use by battery 23. The frame 22 may contain a total of four or more of either springs, shocks, or stabilizers.

Battery 23 may be a mechanical generator or may be a battery, which may be charged. The vibrations absorbed from bump 12 may be captured by spring 18 and ultimately transformed into electrical current that feeds a battery, which may be a form of battery 23, thereby allowing the car to recharge. Thus, every movement of wheel 16 over bump 12 may charge the electric battery inside of automobile 10.

The system, method, and apparatus of energy absorption and actuation as described herein may result in a fully charged automobile 10 electric battery in sixty-seven miles driven by automobile 10. Several factors, including, but not limited to, gravity, spring size, and number of bumps 12 on roadway 14 may influence the number of miles that need to be driven to achieve a fully-charged battery. For example, a larger size spring 18 may significantly increase the energy stored in battery 23.

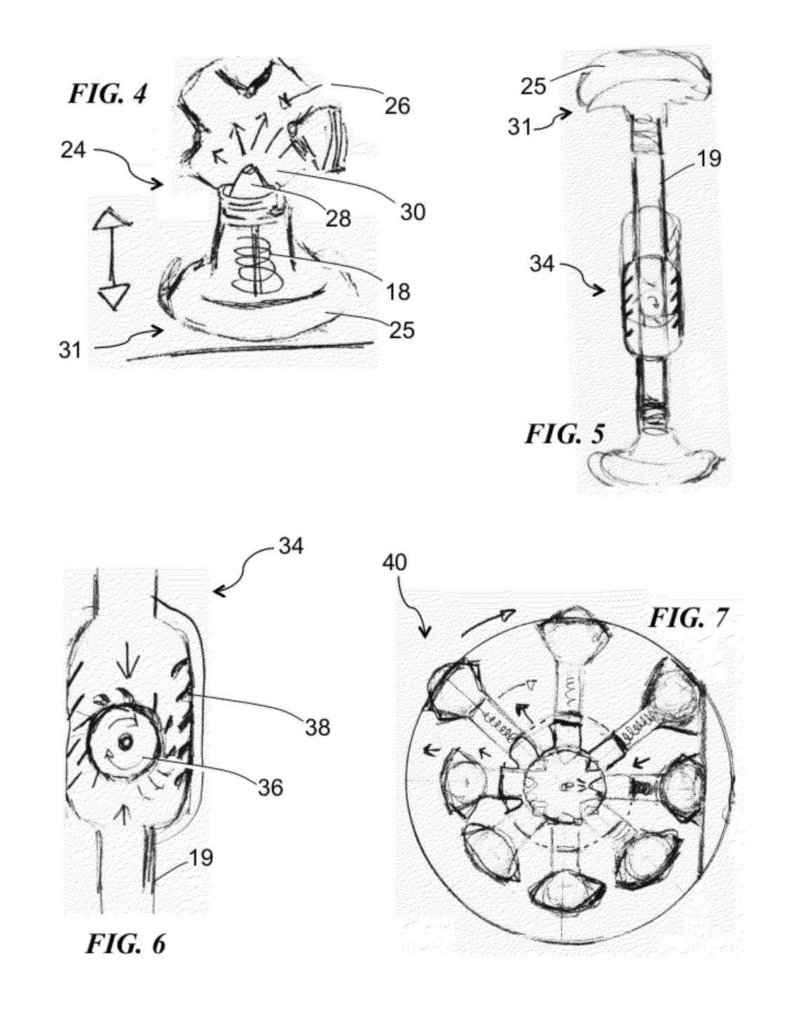

FIG. 4 shows a close-up view of energy generator 24. Subcomponents of energy generator 24 may include, but are not limited to, spring 18, pump 28, cylinder 30, boot 25, and a plurality of piston 26. Spring 18 may be actuated during the rotation 20 of wheel 16 over bump 12. Cylinder 30 may be enclosed inside of casing 19.

In the case of an air generator, in which the air inside of casing 19 is compressed, the actuated spring 18 may initiate pump 28 to pump and/or modulate air into cylinder 30, thereby causing a movement of air into a plurality of air pistons 26.

Energy generator 24 may be rated to absorb one-thousand to four-thousand pounds per square inch of pressure. Further, as the automobile 10 slows down, even more energy may be absorbed and transformed by the system, method, and apparatus described herein, which may increase the rated pressure.

Further, boot 25 may be a sub-component of piston head 31. The compression of boot 25 may actuate spring 18. Further, the rotation 20 of wheel 16 may cause a translation motion associated with piston head 31 due to the presence of gravity and the weight associated with automobile 10; in doing so, further energy is generated by automobile 10 via the implementation of an exemplary rack-and-pinion mechanism 34, as described in FIGS. 6 and 7.

FIG. 5 displays rack-and-pinion mechanism 34, which may be enclosed by casing 19. In the case of an air generator, in which the air inside of casing 19 is compressed, the air inside of rack-and-pinion mechanism 34 may be compressed due to pressure generated inside of casing 19. The resulting compressed air in air tank 32 may provide a source of energy for battery 23. In an alternative embodiment of the present disclosure, a magnetic motion piston may be utilized to compress the air inside of casing 19.

During the motion of automobile 10 over bump 12 on roadway 14, the rotation of wheel 16 may cause coincident rotation of energy generator 24 relative to a stationary observer reference frame. The coincident rotation of energy generator 24 generates additional energy for automobile 10 via rack-and-pinion mechanism 34.

Further, as shown in FIG. 6, rack-and-pinion mechanism 34 may contain rack 38 and pinion 36 that may be utilized to transmit energy to battery 23. In the case of an air generator, the compression of the air inside of casing 19 may drive the rack 38 and pinion 36 repeatedly, thereby generating energy.

FIG. 7 illustrates a plurality of energy generator 24 arranged to achieve an efficient pressure response. The plurality of energy generator 24, may be subcomponents for the wheel-harvester mechanism 40, which may also help to achieve a smooth ride and/or slow automobile 10 down if needed.

Although particularly described with reference to a number of automobile components, such as spring 18, automobile frame 22, pump 28, pinion 36, and rack 38, the present disclosure is intended to include any number of these components.

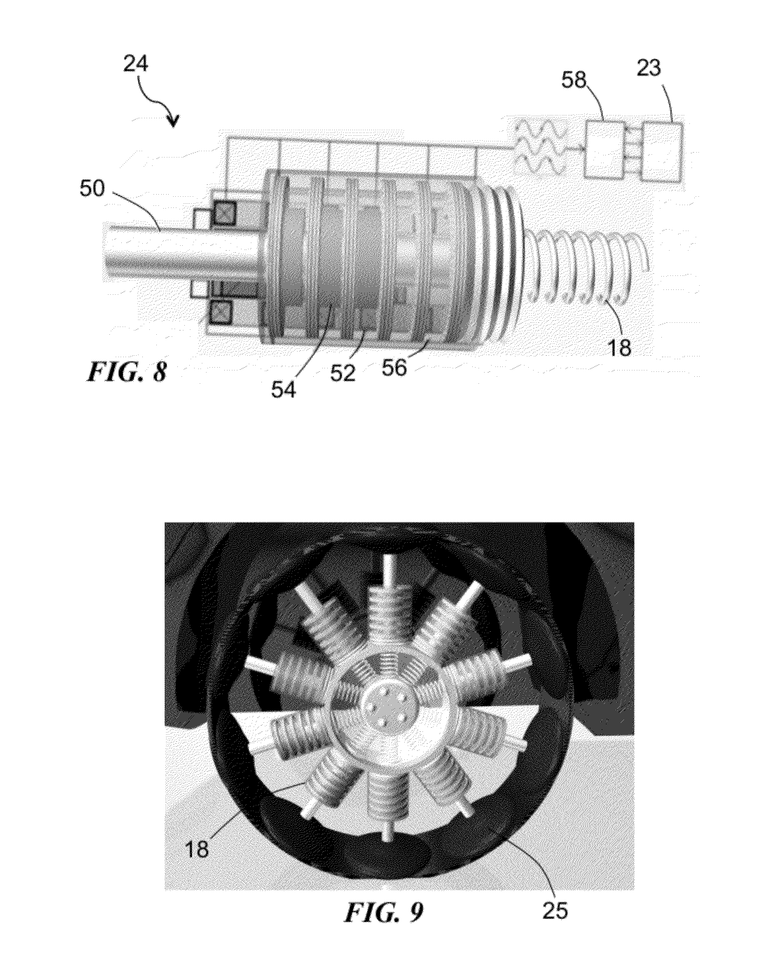

FIG. 8 portrays an embodiment of the energy generator 24, which is further comprised of uniquely-positioned sub-components, which may include, but is not limited, to piston rod 50, coil 52, permanent magnet 54, back-iron 56, and power unit 58. Exemplary apparatus provides for the vector superposition of the magnetic fields from a plurality of adjacent permanent magnet 54 to maximize radial magnetic flux density within coil 52 windings for optimal power generation and energy conversion efficiency of automobile 10.

In one embodiment, a concentric assembly of a plurality of coil 52 may reciprocate within a stationary permanent magnet 54. Further, a plurality of back-iron 56 may serve as spacers and to bend the magnetic field lines and superpose the radial magnetic flux from adjacent permanent magnet 54. The relative motion of an assembly of coil 52 within a region of maximum average magnetic flux density produces efficient electrical power generation and electromagnetic dampening.

Exemplary apparatus may be particularly useful in automobile application. However, exemplary apparatus may be applied to any type of conversion and recovery of electrical energy from repetitive displacement motion, forces and vibrations from a variety of sources, which may include, but is not limited to, stationary or portable machinery, vehicles, boats, trains, aircraft, tidal current, ocean wave motion, military transportation, bridges, and railways.

FIG. 9 shows an embodiment of system, method, and apparatus for actuating the energy that is absorbed by an automobile. Exemplary apparatus provides an efficient, variable frequency, regenerative, and high power generating capacity and high energy conversion efficiency. Further, exemplary automobile 10 energy absorbing and actuating apparatus requires minimal installation time and little to no maintenance.

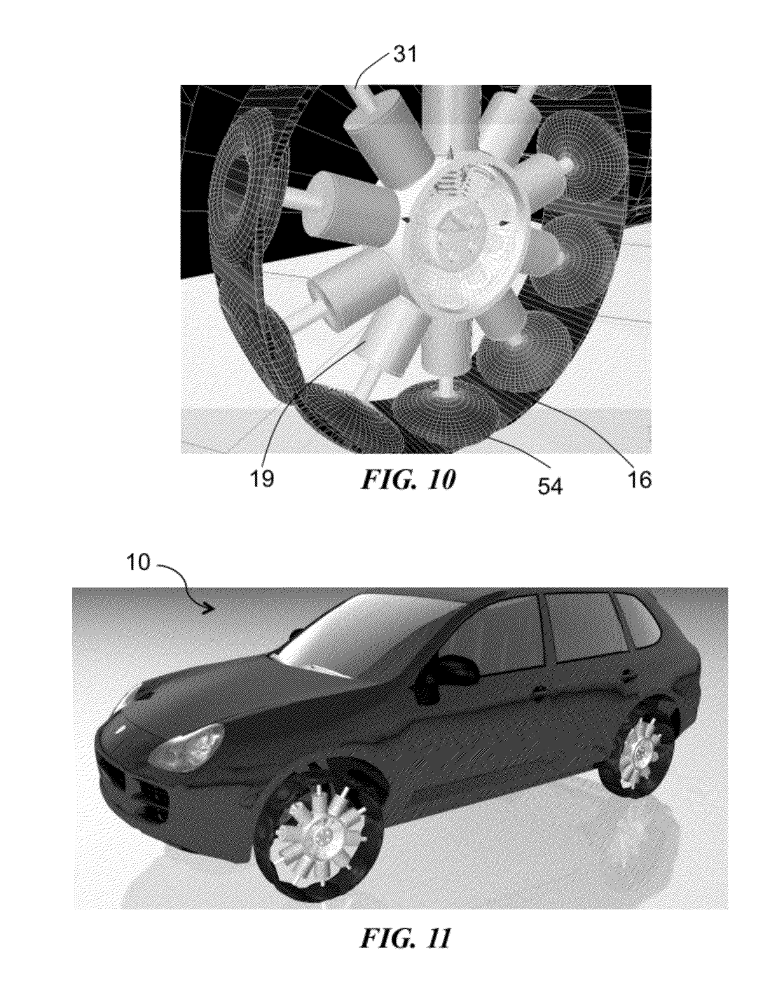

FIG. 10 displays a perspective view of an embodiment system, method, and apparatus for actuating the energy that is absorbed by automobile 10. Exemplary apparatus converts parasitic road displacement motion and vibrations into useful electrical energy for powering automobile 10 and charging battery 23. The present disclosure teaches a method to control electromagnetic dampening to match road impedance while controlling safety and comfort.

FIG. 11 depicts an automobile with an exemplary system, method, and apparatus for providing an alternative energy source to automobile 10. The energy of automobile 10 traversing any roadway 14 may be significant and typically is dissipated as heat via conventional shock absorbers.

The present disclosure teaches a system, method, and apparatus to utilize and recover actuated vibrational energy of automobile 10 towards additional onboard electricity and ultimately fuel economy gains. Further, the present subject matter discloses a system, method, and apparatus to improve the ride quality of automobile 10 on varying types of terrain.

Further, although exemplary devices and schematics implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. An automobile energy absorbing and actuating system, method, and apparatus, comprising a plurality of energy generators disposed of in the circumference of a wheel of an automobile such that as the wheel transverses over a bump, the rotation of the wheel over the bump actuates the energy generators to absorb kinetic energy and produce useful work for the automobile.
